(19) United States
(12) Patent Application Publication
(10) Pub. No.: US 2014/0220198 A1
(43) Pub. Date: Aug. 7, 2014

(54) ULTRASONICALLY-TREATED NUTRITIONAL PRODUCTS HAVING EXTENDED SHELF LIFE

(71) Applicant: ABBOTT LABORATORIES, Abbott Park, IL (US)

(72) Inventor: GUL KONUKLAR, New Albany, OH (US)

(73) Assignee: ABBOTT LABORATORIES, ABBOTT PARK, IL (US)

(21) Appl. No.: 14/244,616

(22) Filed: Apr. 3, 2014

Related U.S. Application Data
(62) Division of application No. 13/698,565, filed on Jan. 15, 2013.
(60) Provisional application No. 61/345,723, filed on May 18, 2010.

(51) Int. Cl. A23L 1/025

(52) U.S. Cl. CPC A23L 1/0252
USPC 426/238; 426/656

(57) ABSTRACT

Disclosed are nutritional products and nutritional bars having increased shelf life. The nutritional product or nutritional bar is manufactured utilizing high power ultrasound in combination with an extrusion process or slabbing process. It has been found that by utilizing high power ultrasound during the manufacturing process of nutritional products and nutritional bars, that the resulting product has increased shelf life and improved texture. In some embodiments, the nutritional bars include a solid crisp matrix.

### FIELD OF THE DISCLOSURE

The present disclosure relates to ultrasonically-treated nutritional products, such as nutritional bars that have extended shelf life. The present disclosure also relates to methods of manufacturing nutritional products using high power ultrasound.

### BACKGROUND OF THE DISCLOSURE

Many nutritional products, and specifically nutritional bars, food bars, snack bars, energy bars and the like, contain significant amounts of protein materials. Typical protein-containing ingredients may include soy and whey isolates, which can differ in functional properties, such as emulsification, water-binding, and gel strength. Protein ingredients such as soy protein isolate, whey protein isolate, sodium or calcium caseinate, whole milk protein and others that exhibit significant viscosity, gel strength, and water-binding properties, significantly influence the initial textural properties of the nutritional bar.

Nutritional bars that include protein-containing ingredients, and specifically high levels of protein-containing ingredients, typically harden over their shelf life, thus reducing commercial acceptability over their shelf life. Proteins that exhibit high water-binding properties are thought to positively influence the initial texture of the bar, but are believed to have the effect of firming the bar's texture over its shelf life. It is generally believed that the firming is not caused by water loss per se, but rather, by migration of the water from some ingredients to others, such as from the carbohydrate fraction to the protein fraction. This hardening or firming of the nutritional bar over time is generally thought to be the result of the dual cause of protein aggregation and the formation of crystalline-like structures by the carbohydrate fractions.

A variety of different carbohydrates, such as gums, maltodextrin, and cellulose derivatives, are added to nutritional bar formulations to hold moisture and to modify texture. While those ingredients may be somewhat effective in preventing moisture loss to the environment, their effectiveness in preventing moisture transfer to protein ingredients is minimal. Increasing the amount of carbohydrates, such as maltodextrin, that take on a crystalline-like form upon moisture loss, is believed to enhance the firming effect during shelf life, thus reducing commercial acceptability.

There is therefore a need for nutritional bars and related nutritional formulations that provide the intended nutrition, energy, and the like, that maintain a soft texture over time leading to an improved shelf life.

### SUMMARY OF THE DISCLOSURE

The present disclosure is directed to a composition comprising an ultrasonically-treated nutritional formulation and a sealed package, the nutritional formulation comprising a carbohydrate in an amount of from about 5% to about 95% by weight of the nutritional formulation a protein in an amount of from about 5% to about 95% by weight of the nutritional formulation, and a lipid in an amount of from about 1% to about 30% by weight of the nutritional formulation, wherein the nutritional formulation has a shelf life of at least three months.

The present disclosure is further directed to a process of manufacturing an ultrasonically-treated nutritional formulation having improved shelf life. The process comprises combining a protein, a carbohydrate, a lipid, a binder, and water to form a slurry, subjecting the slurry to high power ultrasound, and extruding the slurry to produce the ultrasonically-treated nutritional composition.

The present disclosure is further directed to a process of manufacturing an ultrasonically-treated nutritional formulation having improved shelf life. The process comprises combining a protein, a carbohydrate, a lipid, a binder and water to form a slurry, subjecting the slurry to high power ultrasound, and slabbing the ultrasonically-treated slurry to produce the ultrasonically-treated composition

It has been found that high power ultrasound can be utilized to manufacture a nutritional bar having an extended shelf life. By subjecting a nutritional slurry utilized to prepare the nutritional bar to high power ultrasound at the appropriate time during the manufacturing process, the resulting nutritional bar maintains a softer texture over an extended time and its shelf life is increased as the high power ultrasound appears to inhibit and/or delay water migration to the surface of the manufactured bar, thus increasing shelf life by maintaining softness. Additionally, the improved shelf life may be linked to conformational changes of the polymers present in the bars due to the application of high power ultrasound. It has been found that by applying high power ultrasound to a nutritional bar slurry prior to and/or during extrusion, or prior to slabbing, an extended shelf life nutritional bar may be produced.

The nutritional formulations and nutritional bars of the present disclosure that are prepared utilizing high power ultrasound have the advantage of having an increased shelf life, relative to nutritional bars not made utilizing high power ultrasound in the manufacturing process. Prior to the present disclosure, hardening of the texture of nutritional bars over time was a problem, even when the bars were wrapped in moisture and oxygen tight packaging, resulting in shortened shelf life. The texture of the nutritional bars of the present disclosure at any given point in time during the shelf life of the product may be substantially similar to the texture of the nutritional bars when first manufactured. A nutritional bar with an increased shelf life according to the present disclosure is therefore a nutritional bar that exhibits reduced hardening over time.

In addition to the advantages outlined with respect to texture, softness, and shelf life, it has been unexpectedly found that the ultrasonically-treated nutritional formulations and nutritional bars of the present disclosure also advantageously are prepared from slurries that are more visually pleasing; that is, the slurries that are subjected to the high power ultrasound process prior to being formed into a bar or similar product present a creamier, darker, more consistent and homogeneous look, which translates into a more desirable, commercially acceptable product. This results in an overall improved appearance of the nutritional bar product, and may actually conceal some components, such as the protein component, better than current nutritional bars, which also results in a more visually pleasing product such that a consumer would not expect the resulting product to be a “high protein” product.

### BRIEF DESCRIPTION OF THE DRAWINGS

FIG. 1 is a schematic diagram of an ultrasonically-assisted extrusion apparatus suitable for use in the extrusion processes of the present disclosure.

### DETAILED DESCRIPTION OF THE DISCLOSURE

The nutritional formulations and corresponding manufacturing methods of the present disclosure are directed to nutritional bars or other solid product forms, optionally containing a solid crisp matrix, as defined herein, that have been manufactured utilizing high power ultrasound at one or more specific times during the manufacturing process. These and other essential or optional elements or limitations of the nutritional formulations and methods of the present disclosure are described in detail hereinafter.

The term “solid crisp matrix” as use herein, unless otherwise specified, is a term of art within the nutrition formulation art which refers to light, crispy food products having a low bulk density character similar to rice crisps, corn crisps, or similar other well known carbohydrate-containing or protein-containing materials and which have a bulk density of less than about 0.4 g/cm³, preferably less than about 0.35 g/cm³, even more preferably from about 0.10 g/cm³ to about 0.30 g/cm³, and even more preferably from about 0.22 g/cm³ to about 0.28 g/cm³, including from about 0.24 g/cm³ to about 0.27 g/cm³. The term “solid crisp matrix” includes free flowing crisp particulates, bound aggregates of such particulates, and/or solid bar-like matrices, provided that all such particulates, aggregates, or matrices also have the requisite bulk density character as described herein.

The term “sealed package” as used herein refers to a suitable plastic or foil food grade package that encloses and seals in an air tight manner a nutritional formulation, such as a nutritional bar, from air.

The term “shelf life” as used herein refers to a product's commercially viable life-span, after which the product is unfit or undesirable for sale and/or consumption.

All percentages, parts and ratios as used herein, are by weight of the total formulation, unless otherwise specified. All such weights as they pertain to listed ingredients are based on the active level and, therefore, do not include solvents or byproducts that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the present disclosure may also be substantially free of any optional or selected essential ingredient or feature described herein, provided that the product still contains all of the required ingredients or features as described herein. In this context, and unless otherwise specified, the term “substantially free” means that the selected product contains less than a functional amount of the optional ingredient, typically less than 0.1% by weight, and also including zero percent by weight of such optional or selected essential ingredient.

The nutritional formulations, nutritional bars and corresponding manufacturing methods of the present disclosure can comprise, consist of, or consist essentially of the essential elements and limitations of the disclosure as described herein, as well as any additional or optional ingredients, components, or limitations described herein or otherwise useful in nutritional formulation formula applications.

### Product Form

The nutritional formulations of the present disclosure are ultrasonically treated nutritional formulations generally including at least lipid, protein, carbohydrate, and binder. The nutritional formulations are typically nutritional bars, such as snack bars, meal replacement bars, energy bars, blunted glycemic response bars (diabetic bars), weight loss bars, and the like that are formed by extrusion or slabbing.

The nutritional bars of the present disclosure generally have a moisture content of from about 5% to about 20% (by weight), or even from about 3% to about 15% (by weight), or even from about 5% to about 10% (by weight), or even from about 7% to about 9% (by weight).

The ultrasonically treated nutritional formulations have increased shelf life as compared to conventionally prepared nutritional formulations. The shelf life for the nutritional bars of the present disclosure is at least about 3 months, or even at least about 4 months, or even at least about 5 months or even 12 months, or even 18 months, including from 6 to 18 months.

The nutritional formulations may be formulated with sufficient kinds and amounts of nutrients so as to provide a sole, primary, or supplemental source of nutrition, or to provide a specialized nutritional formulation for use in individuals afflicted with specific diseases or conditions.

### Macronutrients

The nutritional formulations and nutritional bars generally comprise at least lipid, protein, and carbohydrate. Generally, any source of lipid, protein, and carbohydrate that is known or otherwise suitable for use in nutritional formulations may also be suitable for use herein, provided that such macronutrients are also compatible with the essential elements of the nutritional formulations as defined herein.

Although total concentrations or amounts of the lipid, protein, and carbohydrates may vary depending upon the nutritional needs of the intended user, such concentrations or amounts most typically fall within one of the following embodied ranges, inclusive of any other essential lipid, protein, and or carbohydrate ingredients as described herein.

### Carbohydrate

The nutritional formulations of the present disclosure comprise a carbohydrate source. The carbohydrate concentration most typically ranges from about 5% to about 95%, including from about 1% to about 50%, including from about 10% to about 30% by weight of the nutritional formulation. The carbohydrate source may be any known or otherwise suitable source that is safe and effective for oral administration and is compatible with the essential and other ingredients in the selected product form.

Suitable carbohydrates or carbohydrate sources for use in the nutritional formulations may be simple, complex, or variations or combinations. Non-limiting examples of suitable carbohydrates include hydrolyzed or modified starch or cornstarch, maltodextrin, glucose polymers, oligosaccharides (e.g., fructooligosaccharides, glucooligosaccharides), sucrose, corn syrup, corn syrup solids, rice-derived carbohydrate, glucose, fructose, lactose, high fructose corn syrup, honey, sugar alcohols (e.g., maltitol, erythritol, sorbitol), and combinations thereof.

Other suitable carbohydrates include any dietary fiber or fiber source, non-limiting examples of which include insoluble dietary fiber sources such as oat hull fiber, pea hull fiber, soy hull fiber, soy cotyledon fiber, sugar beet fiber, cellulose, corn bran, and combinations thereof.

The carbohydrate for use in the nutritional formulation may therefore include soluble and/or insoluble fiber, or other complex carbohydrate, preferably having a DE (dextrose equivalent) value of less than about 40, including less than 20, and also including from 1 to 10.

### Lipid

The nutritional formulations of the present disclosure may comprise a lipid or lipid source. The lipid concentration most typically ranges from about 0% to about 90%, including from about 1% to about 30%, including from about 3% to about 15% by weight of the nutritional formulation. The lipid or lipid source may be any known or otherwise suitable source that is safe and effective for oral administration and is compatible with the essential and other ingredients in the selected product form.

Lipids or lipid sources suitable for use in the nutritional formulations include coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, flaxseed oil, borage oil, cottonseed oils, evening primrose oil blackcurrant seed oil, transgenic oil sources, fungal oils, marine oils (e.g., tuna, sardine) and so forth. Other suitable lipids include both essential and non-essential fatty acids, including omega-3 fatty acids, omega-6 fatty acids, and combinations there.

### Protein

The nutritional formulations of the present disclosure also comprise a protein or protein source. The protein concentration most typically ranges from about 5% to about 95%, including from about 1% to about 20%, including from about 2% to about 10% by weight of the nutritional formulation. The protein or protein source may be any known or otherwise suitable source that is safe and effective for oral administration and is compatible with the essential and other ingredients in the selected product form.

Protein or protein sources suitable for use in the nutritional formulations include hydrolyzed, partially hydrolyzed or non-hydrolyzed proteins or protein sources, and can be derived from any known or otherwise suitable source such as milk (e.g., casein, whey), animal (e.g., meat, fish, egg albumen), cereal (e.g., rice, corn), vegetable (e.g., soy, pea, potato), or combinations thereof. The proteins for use herein can also include, or may be entirely or partially replaced by, free amino acids known for use in nutritional formulations, non-limiting examples of which include tryptophan, glutamine, tyrosine, L-methionine, cysteine, taurine, L-arginine, carnitine, and combinations thereof.

In one embodiment, the nutritional formulations of the present disclosure comprise a soy protein component, sources of which include, but are not limited to, soy flakes, soy protein isolates, soy protein concentrate, hydrolyzed soy protein, soy flour, soy protein fiber, or any other protein or protein source derived from soy. Commercial sources of soy protein are well known in the nutrition art, some non-limiting examples of which include soy protein isolates distributed by The Solae Company under the trade designation “Soy Protein Isolate EXP-H0118,” “EXP-E-0101, and “Supro Plus 675.

### Macronutrient Profile

The total amount or concentration of lipid, carbohydrate, and protein, in the nutritional formulations of the present invention can vary considerably depending upon the selected formulation and dietary or medical needs of the intended user. Additional suitable examples of macronutrient concentrations are set forth below. In this context, the total amount or concentration refers to all lipid, carbohydrate, and protein sources in the nutritional formulation. Such total amounts or concentrations are most typically and preferably formulated within any of the embodied ranges described in the following table.

Macronutrients*

| | Percentage of total | | | Wt/wt percent of Nutritional | | |
|---|---|---|---|---|---|---|
| | calories | | | Formulation | | |
| Nutrients | A | B | C | A | B | C |
| Carbohydrate | 5-95 | 10-70 | 40-50 | 5-95 | 1-50 | 10-30 |
| Lipid | 0-100 | 20-65 | 35-55 | 0-90 | 1-30 | 3-15 |
| Protein | 5-95 | 5-40 | 15-25 | 5-95 | 1-20 | 2-10 |

Each numerical value is preceded by the term “about”

### Binder

The nutritional formulations of the present disclosure also comprise a binder or binding agent that acts as a “glue” for combining and providing structure to various relatively dry ingredients. The binder concentration most typically ranges from about 1% to about 25%, including from about 1% to about 20%, including from about 2% to about 15% by weight of the nutritional formulation. The binder or binding agent source may be any known or otherwise suitable source that is safe and effective for oral administration and is compatible with the essential and other ingredients in the selected product form.

Binders suitable for use in the nutritional formulations of the present disclosure include sugar containing and sugar free binders, such as syrups, such as corn syrup, sugar free syrups, shortening, alcohols, and the like. One specific example of a suitable binder is a sugar free marshmallow binder.

### Solid Crisp Matrix

The ultrasonically-treated nutritional formulations of the present disclosure are generally directed to solid dietary product forms, preferably nutritional snack or nutritional meal replacement bars, as noted above. In some embodiments, the nutritional formulations include a solid crisp matrix, as defined herein. Any solid dietary product form, known or otherwise, is suitable for use herein. It is generally preferred that the solid crisps that make up the solid crisp matrix, if utilized in the nutritional formulation, such as a nutritional bar, be added to the slurry for forming the nutritional formulation after the slurry has been subjected to the high power ultrasound to minimize deterioration of the crisps in the end product.

Because of the nature of the interaction of the components conventionally utilized to manufacture nutritional bars and other nutritional formulations (i.e., protein, carbohydrate, lipid, binder, etc.), and the amounts of these components, nutritional bars prepared by conventional processes (i.e., processes not utilizing high power ultrasound as described herein) have the ability to hold shape and resist deformation after extrusion or slabbing, as described herein. When a solid crisp matrix is added to a conventionally prepared nutritional bar, additional density and structure is provided by the solid crisp matrix, and the slurries prepared and containing the solid crisp matrix can easily be conventionally extruded or slabbed into the desired nutritional bar without the problem of deformation; that is, they generally hold their shape very well after extrusion or slabbing and can easily be cut without deformation, as compared to some extruded or slabbed slurries containing different starting materials that tend to deform or collapse after extrusion or slabbing (such as pretzel dough, shortbread dough, cracker dough, bread, etc, which include different components as compared to nutritional bars).

When present, the solid crisp matrix of the nutritional formulations of the present disclosure generally comprises: 1) from about 10% to about 89% by weight of a carbohydrate other than, and in addition to, an optional soluble viscous fiber; 2) from about 1% to about 49% by weight of protein; and 3) optionally from about 10% to about 50% by weight of a soluble viscous fiber. Each of these components of the solid crisp matrix is described hereinafter in greater detail.

The nutritional formulations of the present disclosure may include a combination of the solid crisp matrix along with one or more other solid crisp materials, wherein the other solid crisp material does not contain a soluble viscous fiber or does not otherwise contain more than about 9% by weight of a soluble viscous fiber. The other solid crisp material may represent within the nutritional formulation from zero percent to about 99%, including from about 5% to about 90%, also including from about 20% to about 80%, and also including from about 30% to about 50%, by weight of the combination of the solid crisp matrix and the solid crisp material in the formulation. Such other solid crisp material includes any conventional or otherwise known grain-based crisp, preferably having a bulk density within the ranges described herein for the essential solid crisp matrix component of the nutritional formulation. Non-limiting examples of such other solid crisp materials include soy crisps, rice crisps, corn crisps, tapioca starch in crisp form, various multi-grain crisps, and combinations thereof.

The optional solid crisp matrix component of the nutritional formulation or nutritional bar of the present disclosure, alone or in combination with an additional crisp material as described above, preferably represents from about 5% to 100% by weight of the nutritional formulation, including from about 50% to about 98%, and also including from about 75% to about 95%, and also including from about 80% to about 90%, by weight of the nutritional formulation. The nutritional formulation may also comprise from zero to 95% by weight of optional materials such nuts or seeds, fruit or other flavored materials, processing aids (e.g., binders), antioxidants, vitamins and minerals, and so forth.

The solid crisp matrix as formulated into the nutritional formulation may be an aggregate of low bulk density materials or food particles bound together, or a continuous or substantially continuous low bulk density matrix, wherein the solid crisp matrix has a bulk density of less than about 0.4 g/cm³, preferably less than about 0.35 g/cm³, even more preferably from about 0.10 g/cm³ to about 0.30 g/cm³, and even more preferably from about 0.22 g/cm³ to about 0.28 g/cm³, including from about 0.24 g/cm³ to about 0.27 g/cm³.

The bulk density of the solid crisp matrix can be measured or otherwise determined by most any conventional method, wherein the bulk density is the mass or weight (gm) per unit volume (cm³) of the matrix, whether the matrix is a solid porous bar or a formed or free flowing aggregate of smaller solid crisp matrices, with air or gaseous voids dispersed throughout and between the matrices.

The solid crisp matrix may be prepared by any method suitable for making a low bulk density material as described herein. In one embodiment, the solid crisp matrix may be prepared by an extrusion process, such as a high temperature short time (HTST) extrusion as a continuous cooking process. The crisp ingredients are combined (e.g., rice flour, guar gum, tricalcium phosphate, maltodextrin, soy protein isolate, water), and the combination metered into a feed line with additional moisture (steam) to an extrusion barrel and conveyed forward by a screw or a series of screws. Within the screw, there is a groove that becomes progressively shallower towards the exiting end of the barrel. The mechanical energy, imparted to the feed, is transformed into heat to cook the feed. To further facilitate this cooking, the barrel can be heated. This combination of moisture and heat transforms the feed powder into a dough. When the temperature of the dough exceeds 100° C., the water becomes super-heated. And as the dough exits the die, the super-heated water explodes and causes expansion of the dough. This expanded dough can be cut into small pieces and dried or toasted which results in a solid crisp matrix for use in the nutritional formulations of the present invention. The process is controlled by conventional means to deliver the requisite bulk density. Some suitable methods of making such low bulk density food particles or materials in forming a solid crisp matrix are described, for example, in U.S. Pat. No. 6,676,982 (Mody), which description was previously incorporated herein by reference.

The solid crisp matrix, regardless of the method used in preparing it, is most typically in the form of individual, free flowing, crispy particles, which can then be combined to form a continuous or discontinuous solid matrix within the nutritional formulation, all of which may be prepared by conventional bar manufacturing methods using such food particle crisps as an ingredient.

The nutritional formulations of the present invention may be prepared in most any dietary product forms of any size or configuration, e.g., rounded or cylindrical, circular or wafer-like, rectangular or in a conventional bar form, or random or other defined shapes. These product forms also include small bite size solids, including those that are packaged as a plurality of bites within a single container or package. The solid crisp matrix may also be packaged as free flowing food particles, e.g., breakfast cereal, in an appropriate box or other package.

The nutritional formulations of the present invention may contain one or more layers of the solid crisp matrix, or may otherwise contain one or more discrete regions of the solid crisp matrix in a random, arranged, or patterned configuration. The nutritional formulation, as well as the solid crisp matrix therein, may be partially or completely coated with any suitable coating material, some common examples of which include yogurt, chocolate, or other confectionary or otherwise flavored material.

### Soluble Viscous Fiber

The optional solid crisp matrix of the nutritional formulations of the present disclosure may optionally comprise from about 1% to about 50%, preferably from about 15% to about 40%, including from about 19% to about 46%, and also including from about 21% to about 32%, of a soluble viscous fiber by weight of the solid crisp matrix. The soluble viscous fiber is preferably guar.

The term “soluble viscous fiber” as used herein, unless otherwise specified, may include any fiber or fiber containing material that is both viscous and soluble as defined herein. A soluble fiber for purposes of the present invention is defined by the American Association of Cereal Chemists (AACC) Method 32-07, wherein a soluble fiber or fiber source is one in which at least 60% of the dietary fiber is soluble dietary fiber as determined by AACC Method 32-07.

The term “viscous fiber” as used herein, unless otherwise specified, refers to a soluble fiber that when formulated into a solid crisp matrix may provide the matrix with an in vivo viscosity greater than about 300 centipoise (cps), including at least about 1,000 cps, also including from about 1,000 cps to about 10,000 cps, and also including from about 3000 cps to about 10,000 cps.

The in vivo viscosity for purposes of characterizing soluble viscous fibers is measured by the following method: (1) prepare an aqueous mixture containing 3% by weight of the solid crisp matrix (10.4 g solid crisp matrix and 349.34 g water); (2) blend the just-formed mixture for 1 minute; (3) raise the blend temperature to about 37° C. by placement in a 37° C. water bath; (4) add 300 microliters of sigma alpha amylase to the warmed and blended mixture; (5) allow the mixture to set for one hour, and then rapidly agitate it over about 0.5 minutes to more fully disperse the incubating mixture; and (6) allow the mixture then to set for a second hour, and then immediately transfer approximately 250 cm³ of the mixture to a 250 cm³ beaker, and then measure the viscosity (e.g. of the transferred mixture using a Brookfield viscometer, #62 spindle, at 3 rpm).

Soluble viscous fibers for use in the solid crisp matrix include any fiber or fiber system satisfying the above described criteria for fiber in vivo viscosity and fiber solubility. The soluble viscous fibers may also be defined in the alternative as being a fiber source comprising one or more of guar gum, gum arabic, sodium carboxymethyl cellulose, locust bean gum, tapioca starch, alginates, tapioca dextrins, citrus pectin, low and high methoxy pectin, carrageenan, barley glucans, carrageenan, psyllium, oat β-glucan, and combinations thereof. Guar gum is preferred.

As the preferred soluble viscous fiber herein, guar gum (galactomannan polymer) is a complex carbohydrate derived from the seed of specially grown bean plants. This carbohydrate is a long chain linear molecule with a molecular weight of approximately 1 million. The long polymer chains attract and weakly capture water; as well as physically tangle with one another in solution thus producing viscosity when mixed with water.

Non-limiting examples of suitable sources of the soluble viscous fibers, including sources of guar gum, are available from Tic Gums, 4609 Richlynn Drive, Belcamp, Md., U.S.A 21017 (Guar 8/24, fine mesh, very high viscosity product).

The soluble viscous fiber may also include two or more soluble viscous fibers, including the dual fiber systems described in U.S. Patent Application 20030125301A1 (Wolf et al.), which description is incorporated by reference herein.

It has been found that the viscous soluble fiber is formulated into the solid crisp matrix to provide palatability benefits (e.g., reduced slimy mouth feel, reduced tooth packing) described herein. And although minor amounts of the fiber may be found elsewhere in the nutritional formulation, the nutrition formulation outside the solid crisp matrix may be substantially free of such fibers, including guar. In this context, the term “substantially free means that the composition may contain less than about 3%, including less than about 2%, and also including less than about 0.1%, and also including zero percent, of such fiber within the nutritional formulation but outside the solid crisp matrix component, all by weight of the nutritional formulation.”

### Acidulant And Sour Flavorant

The nutritional formulations and nutritional bars of the present disclosure may optionally comprise an acidulant, a sour flavorant, or both. Any material that provides a sour and/or acidic flavor that is known or otherwise suitable for use in a solid nutritional product may be used in the formulations of the present disclosure, provided that such materials are safe and effective for oral administration and are compatible with the essential and other ingredients in the selected product form.

It has been found that the acidulant and sour flavorants, especially when used in combination, and even more so when used in combination with pectin pieces as described hereinafter, improves overall mouthfeel and reduces the extent or frequency of tooth packing while chewing and consuming the nutritional formulations. Without being limited by theory, it is believed that the selected acidulants and/or sour flavorants stimulate more salivation than many other flavors (or no flavor at all) and that the increased salivation then acts as a lubricant during chewing to further reduce adhesion of the guar-containing formulation onto the surfaces of the teeth, especially on the crevaced chewing surfaces where undesirable tooth packing most often occurs.

Acidulants suitable for use in the formulations of the present invention include any organic or inorganic edible acid in undissociated form or, alternatively, as their respective salts, for example, potassium or sodium hydrogen phosphate, potassium or sodium dihydrogen phosphate salts, and so forth. Non-limiting examples of suitable acidulants include citric acid, phosphoric acid, malic acid, fumaric acid, adipic acid, gluconic acid, tartaric acid, ascorbic acid, acetic acid, phosphoric acid, and combinations thereof. Acidulant concentrations in the formulation most typically exceed about 0.01% by weight of the formulation, more typically from about 0.05% to about 3%, including from about 0.1% to about 1.0%, by weight of the formulation.

Sour flavorants suitable for use in the formulation of the present disclosure include any natural or artificial favor or combination of flavors, which provides the formulation with sufficient sour notes to be detected during consumption. Non-limiting examples of such sour flavorants include pieces or extracts of, or natural or artificial flavors based upon, natural materials such as strawberry, apple, blueberry, raspberry, blackberry, cherry, orange, lime, lemon, grapefruit, tangerine, bergamot, calamondin, chironja, citron, clementine, dancy, kumquat, limequat, mandarin orange, mandarin lime, minneola, orangelo, orangequat, pummelo, rangpur, satsuma, shaddock, shekwasha, sweety, tangelo, tangor, ugli, or other plant materials containing one or more of the organic acidulants as described herein. Especially useful are dried strawberry pieces (flakes) and/or apple pieces.

Flavorant concentrations can vary considerably depending upon the flavorant, other ingredients in the formulation, the desired overall flavor profile of the formulation, whether the flavor comprises whole fruit or only an extract therefrom, and so forth. Such concentrations, however, most typically and collectively range from at least about 0.01%, more typically from about 0.05% to about 10%, also including from about 0.1% to about 5%, and also including from about 0.5% to about 4%, by weight of the nutritional formulation.

### Gelled Inclusion

The nutritional formulations of the present invention may further comprise one or more gelled inclusions, wherein the inclusions comprise water and not more than about 9%, including from about 0.5% to about 7%, and also including from about 1.5% to about 5%, of a primary gellant by weight of the inclusions, and preferably an acidulant, sour flavorant, or both.

The term “gelled inclusion” as used herein refers to separate gelled structures that are prepared prior to final formulation, and then added to the nutritional formulation as a component of the solid crisp matrix, or as a component separate from the solid crisp matrix. The gelled inclusions can take the form of many gelled particulates or pieces collectively dispersed throughout the solid crisp matrix or other areas of the nutritional formulation, or it can take the form of one or a few larger discrete regions or layers which represent a large, continuous gelled inclusion(s), e.g., a gelled layer(s) on top of or within a nutritional bar embodiment.

Once added to and formulated into the formulation, especially when dispersed as individual particulates throughout the solid crisp matrix or other component of the formulation, the gelled inclusions may lose much if not all of their gelled structure, but still form discreet areas or regions within the nutritional formulation defined by the presence of the selected gellant and any other ingredients specifically formulated into the gelled particulates prior to formulating into the nutritional formulation. Such other ingredients preferably include acidulants, sour-flavorants, or combinations thereof, but may also comprise any of a variety of other optional ingredients such as other flavorants, flavor enhancers, artificial or natural sweeteners, sugar alcohols, etc.

The gelled inclusions preferably represent at least about 1.0% by weight of the nutritional formulation, more preferably from about 1.2% to about 15%, including from about 2% to about 11%, and also including from about 5% to about 9%, by weight of the formulation.

The gellant for use in the gelled inclusions may be any gellant material safe and effective for use in a nutritional formulation, and which is otherwise compatible with the other selected ingredients as formulated within the nutritional formulation. Preferred gellants include the viscous soluble fibers as described herein, to the extent such fibers can form an aqueous gel at the requisite gellant concentration described above. Among the viscous soluble fibers described herein, pectin is most preferred.

The gelled inclusions are preferably formulated into the nutritional formulation in combination with the optional but preferred acidulant, sour flavorant, or both, all as described hereinbefore. The gelled inclusions as particulates are preferably prepared so that the various particulates contain an acidulant and/or sour flavorant, although it is understood that all or some of such acidulants and sour flavorants can also be formulated into the nutritional formulations separate from the gelled inclusion, although the formulation with the gelled inclusion is preferred. When used in combination with a sour flavorant and/or acidulant, the preferred pectin gellant is also preferably a highly methoxylated pectin, most typically those having a degree of esterification of less than about 65%, including less than about 50%.

It has been found that the gelled inclusions such as those containing pectin pieces or other similar particulates, especially when used in combination with an acidulant and sour flavorant, provides for even better performance in reduced tooth packing during consumption, and improved mouthfeel. For purposes of defining the formulations of the present disclosure, therefore, the concentration of the viscous soluble fiber in the crisp solid matrix is considered separate from the concentration of the viscous soluble fiber or gellant concentration provided by the gelled inclusion.

Non-limiting examples of some gelled inclusions suitable for use in the formulations of the present invention, including those containing sour/acid flavored pectin pieces suitable for use herein, include Fantasy® Strawberry NSA Fruit Pieces, Artificial; Natural and Artificial Chocolate Peanut Pieces, NSA; Natural and Artificial Butter-Pecan Pectin Pieces, NSA; Natural and Artificial Espresso Pectin Pieces, NSA; Natural Apple Cinnamon Pectin Pieces, NSA; all of which are available from Sensient, Indianapolis, Ind., U.S.A. Other non-limiting examples of suitable flavored pectin pieces include Realfruitchips, Raspberry No Sugars added—Low Net Carbs, available from Brookside Foods, Ltd., Abbotsford, British Columbia, Canada.

### Optional Ingredients

The nutritional formulations of the present disclosure may further comprise other optional components that may modify the physical, chemical, aesthetic or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the formulations herein, provided that such optional ingredients are safe and effective for oral administration and are compatible with the essential and other ingredients in the selected product form.

Non-limiting examples of such optional ingredients include preservatives, anti-oxidants, buffers, pharmaceutical actives, additional nutrients as described herein, sweeteners including artificial sweeteners (e.g., saccharine, aspartame, acesulfame K, sucralose) colorants, flavorants in addition to those described herein, thickening agents and stabilizers, lubricants, and so forth.

The nutritional formulations of the present disclosure may further comprise in addition to and separate from the materials in the solid crisp matrix, various combinations of the different lipid, carbohydrate, and protein materials described herein, as well as additional vitamins, minerals, or other nutrients.

Non-limiting examples of suitable minerals for use herein include phosphorus, sodium, chloride, magnesium, manganese, iron, copper, zinc, iodine, calcium, potassium, chromium, molybdenum, selenium, and combinations thereof.

Non-limiting examples of suitable vitamins for use herein include carotenoids (e.g., beta-carotene, zeaxanthin, lutein, lycopene), biotin, choline, inositol, folic acid, pantothenic acid, choline, vitamin A, thiamine (vitamin B₁), riboflavin (vitamin B₂), niacin (vitamin B₃), pyridoxine (vitamin B₆), cyanocobalamine (vitamin B₁₂), ascorbic acid (vitamin C), vitamin D, vitamin E, vitamin K, and various salts, esters or other derivatives thereof, and combinations thereof.

### Food Particulates

The formulations of the present disclosure include embodiments formulated as free flowing crisp particulates, which may be a final product form or an intermediate material from which other products may be formulated, such as various solid bar embodiments of the present disclosure. These free flowing crisp particulates comprise any of the solid crisp formulations of the present disclosure, which may further comprise any of the optional ingredients also described herein.

The free flowing crisp particulates may be coated using any material suitable for application to such particulates while also maintaining the free flowing character of such particulates. Such coating materials may be film-forming or non-film-forming materials, most of which are either biopolymers (proteins and polysaccharides) or lipids. Non limiting examples of such coating materials include gluten (e.g., wheat gluten), milk proteins, soy proteins, gelatin, starch (e.g., hydroxypropylated starch), pectinates, cellulose-ethers, hydrophobic fats or waxes, and combinations thereof.

The free flowing crisp particulates may be used as food additives sprinkled onto or mixed within various foods, consumed alone or in combination with other food or beverages as a snack or satiety agent, especially prior to meals. The free flowing crisps may be used as a formulation intermediate in the preparation of other food products such as snack or meal replacement bars or other consumer food products. As a food additive for sprinkling onto or mixing with foods, the free flowing crisp particulates may be formulated with conventional seasoning or other flavors to provide a seasoned or other flavored food additive in particulate form.

When formulated for use as a snack or satiety agent, for use prior to or with a meal, the free flowing crisp particulates include those embodiments comprising in a single dose of up to about 100 kcals, including from 25 to 100 kcals, also including from 40 to 75 kcal, from at least about 6 grams per dose, including from about 7 to about 16 grams, and also including from about 8 to about 12 grams per dose.

Optional ingredients especially useful in these free flowing particulates include sugar alcohols (e.g., maltitol, erythritol, sorbitol, xylitol, mannitol, glycerol, isolmalt, lactitol) or other low glycemic index ingredients, seasoning, phytosterols, glycomacropeptide, and so forth, all of which may be formulated within or on (i.e., coating) the crisp particulates.

For coated particulates, the coating may represent up to 25% by weight of the finished product, including from about 5 to about 20%, and including from about 8 to about 14%, by weight of the finished product.

The methods of the present disclosure are directed to the nutritional formulations of the present disclosure. These methods include the following: (1) the oral administration of the nutritional formulations to individuals to provide a balanced or complete source of nutrition; (2) the oral administration of the nutritional formulations to diabetics or other individuals to provide a blunting of the glycemic response following administration of a snack or meal; (3) the oral administration of the nutritional formulations s to diabetics or other individuals to help reduce appetite; and (4) the oral administration of the nutritional formulations to diabetics or other individuals to help reduce total body weight or total fat content of the individual.

The methods of the present invention may comprise the daily administration of at least one serving of the nutritional formulation, in single or divided doses, to an individual to whom the benefits of such administration would be useful. In this context, a serving is defined as the total daily amount of the nutritional formulation to be administered to the individual, which is most typically in the form of from about 1 to about 6 bars per day, for a total daily caloric intake from the formulation of at least about 50 kcal/day, more typically from about 50 kcal/day to about 3,000 kcal/day, and even more typically from about 120 kcal/day to about 600 kcal/day.

The nutritional formulations of the present disclosure for use in the various methods is preferably a bar formulation comprising a combination of lipid, protein, carbohydrate, vitamins, and minerals, and more preferably comprises from about 99 kcal to about 350 kcal, more preferably from about 120 kcal to about 280 kcal, per individual bar.

### Manufacture

The nutritional formulations of the present disclosure may be prepared by any known or otherwise effective manufacturing technique for preparing the selected solid product form (including nutritional bars) such as, for example, extrusion or slabbing, so long as the slurry utilized to form the nutritional formulation is subjected to high power ultrasound at some point prior to or during the manufacturing process. The high power ultrasound energy may be applied to the nutritional formulation at any time, so long as the nutritional formulation is in a flowable state (a slurry for example). Many such manufacturing techniques are known for any given product form, such as coated or uncoated, layered or un-layered, nutritional bars, and can be applied by one of ordinary skill in the art to the nutritional formulations described based on the disclosure herein.

The methods of the present disclosure utilizing high power ultrasound provide for improved rheology performance of the flowable material during the manufacturing of the nutritional product (i.e., nutritional bar) in the form of a less elastic material. The flowable material subjected to the high power ultrasound and extruded has flowable properties similar to that of honey; that is, the flowable material subjected to the high power ultrasound has more Newtonian-type properties such that it can be pumped and fed into the extruder easier.

In general, the nutritional bars and other solid formulations of the present disclosure are most typically manufactured by conventional methods commonly used for non-baked nutrition bars, so long as the methods include the use of high power ultrasound as described herein. In one specific embodiment, an extrusion process including a high power ultrasound step or steps is utilized to make a nutritional bar. One suitable extrusion process is a conventional high temperature short time (HTST) extrusion as a continuous cooking process including at least one high power ultrasound step wherein the slurry is exposed to high power ultrasound.

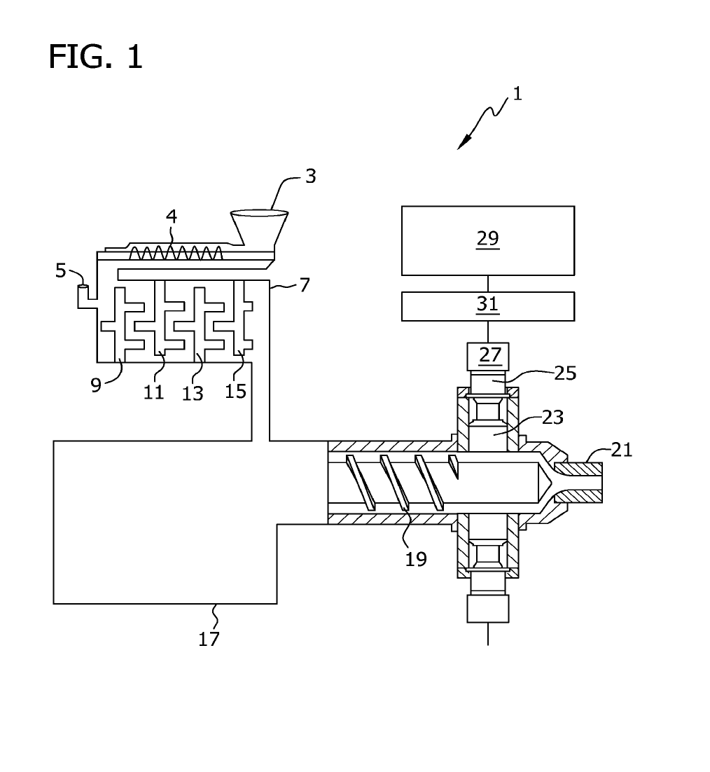

Referring now to FIG. 1, there is shown an extrusion apparatus 1 suitable for use in the high power ultrasound extrusions processes of the present disclosure. The extrusion apparatus 1 includes feeder 3 (which may optionally include one or more stirrers within, not shown) for dry ingredients, feeding screw 4, and liquid additive opening 5 for liquid ingredients. Feeder 3 and liquid additive opening 5 both feed into preconditioner 7, which includes mixing arms 9, 11, 13, and 15. Preconditioner 7 provides a mixture of dry and liquid ingredients for extrusion into extruder 17 including screw 19 (multiple screws may also be used, not shown) and through shaping die 21. Connected to the extruder 17 is horn 23, which provides the high power ultrasound to the extruder 17. Horn 23 is connected to booster 25, which is connected to converter 27 for originating the high power ultrasound. High power ultrasound power supply 29 and wattmeter 31 are also shown.

When an extrusion process is utilized to prepare a nutritional bar, the desired components are first combined (e.g., protein, carbohydrate, lipid, binder, water, flavorings, vitamins, minerals, etc.), to form a slurry, or multiple slurries, that are ultimately combined together at a point prior to extrusion to form a final slurry including all desired components. This resulting slurry is then subjected to high power ultrasound either before extrusion, during extrusion, or both before and during extrusion of the slurry to form the nutritional bar. In some embodiments, if multiple slurries are formed, each of the multiple slurries may be subjected to high power ultrasound individually and then combined into the final slurry, which may or many not be subjected to further high power ultrasound prior to extrusion. If solid crisps are to be added to the extruded nutritional bar such that the resulting nutritional bar includes a solid crisp matrix, they are preferably added to the slurry or slurries after high power ultrasound has been applied to the slurry or slurries and before extrusion. Because the high power ultrasound may, in some embodiments, reduce the structural integrity of the formed crisps in the nutritional bar, it is generally preferred to add the crisps to the slurry or slurries after high power ultrasound has been applied to the slurry or slurries, but prior to the extrusion process. It is within the scope of the present disclosure, however, to add crisps into one or more of the slurries prior to the treatment of the one or more slurries with high power ultrasound such that the crisps are subjected to the high power ultrasound.

High power ultrasound is generally applied to the slurry for a time period of less than about 60 minutes total, including about 50 minutes total, or even about 40 minutes total, or even 30 minutes total, or even 25 minutes total, or 20 minutes total, or 15 minutes total, or 10 minutes total, or 5 minutes total, or even 3 minutes total. In some processes, the slurry ultimately introduced into the extruder may be subjected to multiple rounds of high power ultrasound during formation; that is, a slurry including a first two ingredients may be subjected to high power ultrasound for a few minutes before one or more additional components is added to the ultrasonically treated slurry and then the new slurry, including the additional components may be subjected to high power ultrasound. The slurry ultimately introduced into the extruded may have been subjected to high power ultrasound 1, 2, 3, 4, or even 5 or more times during the preparation process of the ultimate slurry extruded into the final product.

The high power ultrasound applied to the slurry generally has a frequency of less than about 40 Kilohertz, including less than about 30 Kilohertz, or even less than about 20 Kilohertz, or even less than about 15 Kilohertz.

After the slurry is formed and high power ultrasound has been applied to the slurry (as noted above, high power ultrasound may optionally be applied during the extrusion), the slurry is metered into a conventional feed line with additional moisture (steam) to an extrusion barrel and conveyed forward by a screw or a series of screws. Within the screw, there is a groove that becomes progressively shallower towards the exiting end of the barrel. The mechanical energy, imparted to the slurry feed, is transformed into heat to cook the slurry feed. To further facilitate this cooking, the barrel can optionally be heated. This combination of moisture and heat transforms the slurry feed into a dough. When the temperature of the dough exceeds 100° C., the water becomes super-heated. And as the dough exits the die, the super-heated water explodes and causes expansion of the dough. This expanded dough can be cut into desired shapes and sizes and packaged in a sealed package to form ultrasonically treated nutritional bars of the present disclosure having increased shelf life. The process is generally controlled by conventional means to deliver the desired bulk density.

In another suitable embodiment for making nutritional bars of the present disclosure, which does not include an extrusion process, the various components (e.g., protein, carbohydrate, lipid, binder, water, etc.) are combined together with agitation and heated to about 140° F. to form a substantially homogeneous slurry. The slurry is then subjected to high power ultrasound as described above, and then fed into a mixer and optionally combined with solid crisp particles and other ingredients. The resulting slurry is then slabbed (e.g., 0.5-1.0 inch sheets), cut into the desired shapes, optionally coated, cooled, and then packaged in a sealed package to produce an ultrasonically treated nutritional bar having extended shelf life.

In another embodiment of the present disclosure nutritional bars may be produced in any conventional manner, such as by conventional extrusion, and be subjected to high power ultrasound as described herein after extrusion; that is, the nutritional bar may be extruded using conventional means (i.e., means without high power ultrasound) and the formed nutritional bar (not still in a substantially flowable state) subjected to high power ultrasound to impart one or more of the benefits described herein. In this embodiment, the formed bar may be subjected to high power ultrasound immediately after extrusion, or within about 1 minute, or about 2 minutes, or about 3 minutes, or even about 5 minutes, or 10 minutes or even up to about 30 minutes after extrusion.

The formulations of the present disclosure may, of course, be manufactured by other known or otherwise suitable techniques not specifically described herein without departing from the spirit and scope of the present invention. The present embodiments are, therefore, to be considered in all respects as illustrative and not restrictive and that all changes and equivalents also come within the description of the present invention. The following non-limiting examples will further illustrate the formulations and methods of the present invention.

### EXAMPLES

The following examples illustrate specific embodiments and/or features of the nutritional formulations and nutritional bars of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

### Example 1

Example 1 illustrates hardness reduction and toughness reduction in three nutritional samples prepared utilizing high power ultrasound in the preparation process (Samples 1-3) as compared to two control nutritional samples prepared without high power ultrasound (Controls 1-2). The frequency of the high power ultrasound was fixed at 20 KHz and 100% and the power was set at 1,000 W. Each bar dough formed was shaped into a bar and measured for hardness (force measurement) and toughness (area under the force curve) within the same day as being manufactured.

The components of the five nutritional samples prepared and evaluated are set forth in the table below.

| | Control #1 | Control #2 | Sample #1 | Sample #2 | Sample #3 |
|---|---|---|---|---|---|
| Ingredient | Grams | Grams | Grams | Grams | Grams |
| Liquid Ingredients | | | | | |
| Glycerine | 50.8 | 50.8 | 50.8 | 50.8 | 50.8 |
| Energy Smart ® Syrup (mixed fruit | 376.0 | 376.0 | 376.0 | 376.0 | 376.0 |
| juice concentrates and natural grain | | | | | |
| dextrins) | | | | | |
| Maltitol Syrup | 110.5 | 110.5 | 110.5 | 110.5 | 110.5 |
| Chocolate Liquor | 37.6 | 37.6 | 37.6 | 37.6 | 37.6 |
| High Oleic Safflower Oil | 34.3 | 34.3 | 34.3 | 34.3 | 34.3 |
| Water | 46.9 | 46.9 | 46.9 | 46.9 | 46.9 |
| Powder Ingredients | | | | | |
| Soy Protein Isolate | 66.0 | 66.0 | 66.0 | 66.0 | 66.0 |
| Dicalcium Phosphate | 38.6 | 38.6 | 38.6 | 38.6 | 38.6 |
| Calcium Caseinate | 221.1 | 221.1 | 221.1 | 221.1 | 221.1 |
| Maltodextrin (Fibersol 2) DE8-12 | 197.5 | 197.5 | 197.5 | 197.5 | 197.5 |
| Cocoa Powder | 98.9 | 98.9 | 98.9 | 98.9 | 98.9 |
| Fructose | 190.1 | 190.1 | 190.1 | 190.1 | 190.1 |
| Fructo Oligosaccharide (FOS) | 18.8 | 18.8 | 18.8 | 18.8 | 18.8 |
| Maltodextrin 180 | 57.2 | 57.2 | 57.2 | 57.2 | 57.2 |

Control #1 is prepared by mixing together all of the liquid ingredients and heating the resulting mixture to 120° C. Once the temperature is achieved, all of the powdered ingredients are added to the liquid ingredients and the resulting slurry mixed together to form a bar dough.

Control #2 is prepared by first mixing together all of the liquid ingredients and heating the resulting mixture to 120° C., and then adding the soy protein isolate, fructose, maltodextrin 180 and fructooligosaccharides thereto to form a slurry. The slurry is then heated to 170° C. in a microwave oven. Once the temperature is achieved, the remaining powdered ingredients are added to the slurry and mixed together to form a bar dough.

Sample #1 is prepared by first microwaving the chocolate liquor for about 90 seconds and then introducing the remaining liquid ingredients into the chocolate liquor with mixing. The resulting liquid mixture is subjected to high power ultrasound for about 5 minutes. The soy protein isolate is then added to the mixture and the resulting mixture is subjected to high power ultrasound for about 15 minutes. The fructose is then added to the mixture and the resulting mixture is subjected to high power ultrasound for about 10 minutes. The maltodextrin 180 is then added to the mixture and the resulting mixture is then subjected to high power ultrasound for about 10 minutes. One half of the total amount of Fibersol 2 is then added to the mixture and the resulting mixture is subjected to high power ultrasound for about 10 minutes. The remaining powdered ingredients are then mixed into the mixture to form a bar dough.

Sample #2 is prepared by first microwaving the chocolate liquor for about 90 seconds and then introducing the remaining liquid ingredients into the chocolate liquor with mixing. The resulting liquid mixture is subjected to high power ultrasound for about 5 minutes. The soy protein isolate is then added to the mixture and the resulting mixture is subjected to high power ultrasound for about 15 minutes. The fructose is then added to the mixture and the resulting mixture is subjected to high power ultrasound for about 10 minutes. The fructooligosaccharides are then added to the mixture and the resulting mixture is then subjected to high power ultrasound for about 10 minutes. The maltodextrin 180 is then added to the mixture and the resulting mixture is subjected to high power ultrasound for about 10 minutes. The remaining powdered ingredients are then mixed into the mixture to form a bar dough.

Sample #3 is prepared by first microwaving the chocolate liquor for about 90 seconds and then introducing the remaining liquid ingredients into the chocolate liquor with mixing. The resulting liquid mixture is subjected to high power ultrasound for about 30 seconds. The soy protein isolate is then added to the mixture and the resulting mixture is subjected to high power ultrasound for about 1 minute. The fructose is then added to the mixture and the resulting mixture is subjected to high power ultrasound for about 1 minute. The fructooligosaccharides and maltodextrin 180 are then mixed together, and this mixture of fructooligosaccharides and maltodextrin 180 is then added to the mixture and the resulting mixture is then subjected to high power ultrasound for about 1 minute. The remaining powdered ingredients are then mixed into the mixture to form a bar dough.

The hardness and toughness of the control and samples bars were measured using a TA.XTplus Texture Analyzer (Texture Technologies, Scarsdale, N.Y.) wherein hardness was determined as the maximum point on the curve generated and toughness was determined as the area under the same curve. The test used the 45 degree angle Chisel Blade, and the following settings (two distance settings were utilized as each sample was tested at both distances): (1) Test Mode: compression; (2) Pre-Test Speed: 1 millimeter per second; (3) Test Speed: 2 millimeters per second; (4) Post-Test Speed: 10 millimeters per second; (5) Target Mode: Distance; (6) Distance: 5 millimeters and 10 millimeters per second; (7) Trigger Type: Auto (Force); (8) Trigger Force: 5.0 grams; (9) Break Mode Off; (10) Stop Plot At: Start Position; (11) Tare Mode: auto; (12) Advanced Options: On; (13) Control Oven: disabled; and (14) Frame Deflection Correction: off.

The results of the hardness and toughness experiments are shown in the following Table.

| Sample Evaluated | Hardness (Force) | Toughness (Force * Displacement) |
|---|---|---|
| Control #1 | 1203.4 | 2586.4 |
| Control #2 | 566.5 | 1249.2 |
| Sample #1 | 935.4 | 1664 |
| Sample #2 | 261.8 | 323.1 |
| Sample #3 | 443.3 | 971.6 |

As the data in the table above indicate, the application of high power ultrasound during the manufacturing process generally reduces that hardness and toughness of the resulting bar. Also as the data show, variable that impact that textural characteristics of the resulting materials include temperature, time, order of addition of the ingredients, and length of ultrasound. Notably, Samples 2 and 3 had significantly reduced hardness and toughness as compared to the control bars.

Examples 2-6

Examples 2-6 illustrate ultrasonically treated nutritional bar embodiments of the present disclosure, the starting ingredients of which are listed in the following Table.

| | Example 2 | Example 3 | Example 4 | Example 5 | Example 6 |
|---|---|---|---|---|---|
| Ingredient | Grams | Grams | Grams | Grams | Grams |
| Liquid Ingredients | | | | | |
| Glycerine | 52.8 | 54.8 | 56.8 | 58.8 | 59.8 |
| Energy Smart ® Syrup (mixed fruit | 386.0 | 356.0 | 326.0 | 366.0 | 306.0 |
| juice concentrates and natural grain | | | | | |
| dextrins) | | | | | |
| Maltitol Syrup | 110.5 | 110.5 | 110.5 | 110.5 | 110.5 |
| Chocolate Liquor | 37.6 | 37.6 | 37.6 | 37.6 | 37.6 |
| High Oleic Safflower Oil | 34.3 | 34.3 | 34.3 | 34.3 | 34.3 |
| Water | 46.9 | 46.9 | 46.9 | 46.9 | 46.9 |
| Powder Ingredients | | | | | |
| Soy Protein Isolate | 67.0 | 69.0 | 60.0 | 76.0 | 86.0 |
| Dicalcium Phosphate | 38.6 | 38.6 | 38.6 | 38.6 | 38.6 |
| Calcium Caseinate | 241.1 | 187.1 | 276.1 | 219.1 | 201.1 |
| Maltodextrin (Fibersol 2) DE8-12 | 157.5 | 197.5 | 195.5 | 147.5 | 109.5 |
| Cocoa Powder | 98.9 | 98.9 | 98.9 | 98.9 | 98.9 |
| Fructose | 190.1 | 190.1 | 190.1 | 190.1 | 190.1 |
| Fructo Oligosaccharide (FOS) | 18.8 | 18.8 | 18.8 | 18.8 | 18.8 |
| Maltodextrin 180 | 58.2 | 52.2 | 54.2 | 57.2 | 57.2 |
| Total | 100 grams | 100 grams | 100 grams | 100 grams | 100 grams |

The nutritional bars are prepared in accordance with the present disclosure utilizing a high temperature short time (HTST) extrusion as a continuous cooking process. The liquid ingredients are mixed together and heated to a temperature of about 120° C. and the powder ingredients are added thereto to form a slurry. This resulting slurry is then subjected to high power ultrasound (at about 20 KHz) before extrusion for a time period of about 10 minutes.

After the slurry is formed and high power ultrasound has been applied to the slurry, the slurry is metered into a feed line with additional moisture (steam) to an extrusion barrel and conveyed forward by a screw or a series of screws. Within the screw, there is a groove that becomes progressively shallower towards the exiting end of the barrel. The mechanical energy, imparted to the slurry feed, is transformed into heat to cook the slurry feed. This combination of moisture and heat transforms the slurry feed into a dough. When the temperature of the dough exceeds 100° C., the water becomes super-heated. And as the dough exits the die, the super-heated water explodes and causes expansion of the dough. This expanded dough can be cut into desired shapes and sizes and packaged in a sealed package to form nutritional bars of the present disclosure having increased shelf life.

### Example 7-11

Examples 7-11 illustrate ultrasonically treated nutritional bar embodiments of the present disclosure, the starting ingredients of which are listed in the following Table.

| | Example 7 | Example 8 | Example 9 | Example 10 | Example 11 |
|---|---|---|---|---|---|
| Ingredient | Grams | Grams | Grams | Grams | Grams |
| Liquid Ingredients | | | | | |
| Glycerine | 52.8 | 54.8 | 40.8 | 56.8 | 59.8 |
| Energy Smart ® Syrup (mixed fruit | 326.0 | 346.0 | 371.0 | 376.0 | 366.0 |
| juice concentrates and natural grain | | | | | |
| dextrins) | | | | | |
| Maltitol Syrup | 112.5 | 114.5 | 116.5 | 118.5 | 115.5 |
| Chocolate Liquor | 36.6 | 34.6 | 31.6 | 39.6 | 37.6 |
| High Oleic Safflower Oil | 34.3 | 34.3 | 34.3 | 34.3 | 34.3 |
| Water | 46.9 | 46.9 | 46.9 | 46.9 | 46.9 |
| Powder Ingredients | | | | | |
| Soy Protein Isolate | 68.0 | 60.0 | 61.0 | 59.0 | 49.0 |
| Dicalcium Phosphate | 38.6 | 38.6 | 38.6 | 38.6 | 38.6 |
| Calcium Caseinate | 201.1 | 211.1 | 229.1 | 218.1 | 206.1 |
| Maltodextrin (Fibersol 2) DE8-12 | 190.5 | 189.5 | 183.5 | 139.5 | 170.5 |
| Cocoa Powder | 98.9 | 98.9 | 98.9 | 98.9 | 98.9 |
| Fructose | 190.1 | 190.1 | 190.1 | 190.1 | 190.1 |
| Fructo Oligosaccharide (FOS) | 18.8 | 18.8 | 18.8 | 18.8 | 18.8 |
| Maltodextrin 180 | 57.2 | 57.2 | 57.2 | 57.2 | 57.2 |
| Total | 100 grams | 100 grams | 100 grams | 100 grams | 100 grams |

The nutritional bars are prepared in accordance with the present disclosure utilizing a slabbing process. The liquid components and the powdered components are combined together with agitation and heated to about 140° F. to form a substantially homogeneous slurry. The slurry is then subjected to high power ultrasound (about 20 KHz) for about 10 minutes, and then fed into a mixer. The resulting mixed slurry is then slabbed (e.g., 0.5-1.0 inch sheets), cut into the desired shapes cooled, and then packaged in a sealed package to produce a nutritional bar having extended shelf life.

What is claimed is:

1. A composition comprising an ultrasonically-treated nutritional formulation and a sealed package, the nutritional formulation comprising from about 5% to about 95% (by weight) carbohydrate, from about 5% to about 95% (by weight) protein, and from about 1% to about 30% (by weight) lipid.

2. The composition of claim 1 wherein the carbohydrate is present in an amount of from about 10% to about 30% by weight of the nutritional formulation and the protein is present in an amount of from about 2% to about 10% by weight of the nutritional formulation.

3. The composition of claim 1 wherein the nutritional formulation further comprises a lipid in an amount of from about 1% to about 30% by weight of the nutritional formulation.

4. The composition of claim 1 wherein the nutritional formulation further comprising a lipid in an amount of from about 3% to about 15% by weight of the nutritional formulation.

5. The composition of claim 1 wherein the nutritional formulation further comprises a soluble viscous fiber in an amount of from about 10% to about 50% by weight of the nutritional formulation.

6. The composition of claim 5 wherein the soluble viscous fiber comprises guar gum.

7. The composition of claim 1 wherein the nutritional formulation has a bulk density of less than 0.4 g/cm³.

8. The composition of claim 1 wherein the nutritional formulation has a bulk density of from about 0.22 g/cm³ to about 0.28 g/cm³.

9. The composition of claim 1 wherein the nutritional formulation includes a solid crisp matrix.

10. The composition of claim 1 wherein the nutritional formulation has a moisture content of from about 5% to about 10% (by weight).

11. The composition of claim 1 wherein the nutritional formulation has a moisture content of from about 7% to about 9% (by weight).

12. A process of manufacturing an ultrasonically-treated nutritional formulation, the process comprising:
combining a protein, a carbohydrate, a lipid, a binder, and water to form a slurry;
subjecting the slurry to high power ultrasound; and
extruding the slurry to produce the ultrasonically-treated nutritional formulation.

13. The process of claim 12 wherein the slurry is subjected to the high power ultrasound before the extrusion is performed.

14. The process of claim 12 wherein the slurry is subjected to the high power ultrasound simultaneously with the extrusion.

15. The process of claim 12 wherein the slurry is subjected to the high power ultrasound before and simultaneously with the extrusion.

16. The process of claim 12 wherein the high power ultrasound has a frequency of less than about 30 Kilohertz.

17. The process of claim 12 wherein the high power ultrasound has a frequency of less than about 20 Kilohertz.

18. The process of claim 12 wherein the high power ultrasound has a frequency of less than about 15 Kilohertz.

19. The process of claim 13 wherein the slurry is subjected to the high power ultrasound for a time period of about 15 minutes or less prior to extrusion.

20. The process of claim 13 wherein the slurry is subjected to the high power ultrasound for a time period of about 10 minutes or less prior to extrusion.

21. The process of claim 13 wherein the slurry is subjected to the high power ultrasound for a time period of about 5 minutes or less prior to extrusion.

22. The process of claim 13 wherein the slurry is subjected to the high power ultrasound for a timer period of about 3 minutes prior to extrusion.

23. The process of claim 12 wherein the extrusion is a high temperature short time extrusion.

24. The process of claim 12 where solid crisps are introduced into the slurry after the application of high power ultrasound and prior to extrusion.

25. A process of manufacturing an ultrasonically-treated nutritional formulation, the process comprising:
combining a protein, a carbohydrate, a lipid, a binder and water to form a slurry;
subjecting the slurry to high power ultrasound; and
slabbing the ultrasonically-treated slurry to produce the ultrasonically-treated formulation.

26. The process of claim 25 wherein solid crisps are added to the slurry after high power ultrasound is applied and prior to slabbing.

27. The process of claim 26 wherein the solid crisps include guar.

28. The process of claim 25 wherein the nutritional formulation includes from about 1% to about 50% carbohydrate and from about 1% to about 20% protein.

29. The process of claim 25 wherein the nutritional formulation includes from about 10% to about 30% carbohydrate and from about 2% to about 10% protein.

30. The process of claim 27 wherein the nutritional formulation includes from about 3% to about 15% lipid, from about 10% to about 30% carbohydrate, and from about 2% to about 10% protein.
